(19) United States
(12) Patent Application Publication
(10) Pub. No.: US 2015/0121532 A1
(43) Pub. Date: Apr. 30, 2015

(54) SYSTEMS AND METHODS FOR DEFENDING AGAINST CYBER ATTACKS AT THE SOFTWARE LEVEL

(71) Applicant: Nissim Barel, Kfar Saba (IL)

(72) Inventor: Nissim Barel, Kfar Saba (IL)

(73) Assignee: COMSEC CONSULTING LTD, Petach Tikva (IL)

(21) Appl. No.: 14/068,084

(22) Filed: Oct. 31, 2013

(51) Int. Cl. G06F 21/57

(52) U.S. Cl. CPC G06F 21/577
USPC 726/25

(57) ABSTRACT

A method for a customized, scalable and cost-efficient solution to enable source code level solutions to provide zero percentage false positives as well as a controlled false negative ratio to detect software security vulnerabilities accurately and in time. The method includes secure uploading of the source code, initial analysis and customizing according to accuracy and depth defined to enable control of the false negative ratio. The method also includes application processing, advanced analyzing, performing report development and delivering a secure report. The initial analysis provides for a human analyst “built-in” as part of the process that performs the analysis on initial results and the filtering of the results to contain ONLY relevant security vulnerabilities

### FIELD OF THE INVENTION

The present invention generally relates to cyber security and, in particular, to systems and methods for defending against cyber attacks at the software level.

### BACKGROUND OF THE INVENTION

Today, in the online world, cyber-attacks have to be dealt with traditionally as well as proactively. Recent research demonstrates that one of the biggest challenges in providing comprehensive solutions for cyber-attacks are attack vectors focusing on the software level as these attacks are becoming the de-facto cyber arsenal for novice and professional/state sponsored hackers.

Traditional software attacks were focused on public web sites, ecommerce and other online service. However, it's no longer the case today. Modern software attacks are focused on every digital/cyber assets, both directly and indirectly targeting various systems, platforms and solution such as:

### Industrial Controls/SCADA Systems;

### Smartphone Platforms;

### Mobile Apps;

### Gaming Platforms;

Cloud-based services and platforms;

### Client/Server Financial Applications;

### Embedded Devices;

Medical systems and Devices; and

### Smart Automobile Platforms

Supervisory control and data acquisition (SCADA) is a type of industrial control system (ICS). ICS's are computer controlled systems that monitor and control industrial processes. SCADA systems historically distinguish themselves from other ICS systems by being large scale processes that can include multiple sites, spread over large, often global areas. These processes include:

To mitigate software security attacks, software/product vendors and in-house enterprise organizations started to implement Software Security Development Processes (SDL) to detect software vulnerabilities early in the development lifecycles. Industry practices demonstrate that to provide mature and effective SDL processes, security code review is preferably implemented as part of the SDL process, however current tools and practices for performing security code reviews using both static and dynamic methods are considered non scalable and ineffective.

The exponential development of information technologies and the World Wide Web have resulted in the additional dimension referred to as Cyberspace. The diversity of attacks in Cyberspace are often referred to as Advanced Persistent Threats (APT). These threats consist of funded entities such as state sponsored attacks, terror organizations or professional organized crime. The unique and special properties of Cyberspace, especially the ease to gain access to advanced technologies and its connective nature, enable “small time” players to gain powerful cyber security capacities, especially attacking abilities. This is referred to as the property of asymmetry. In general the threats arise from organizes crime, insiders, hacktivists, script kiddies, nations, terror groups, malware authors and new emerging threats. The environments in which threats arise include social engineering, botnets, social networks and media, malicious code, cloud computing, mobile platforms, infected Websites and the Dark Net, also known as the Deep Web.

The maturity of the secure Software Development Lifecycle (SDL) approach of incorporating security from the earliest stages of development, and multiple regulatory compliance standards such as the Payment Card Industry's Data Security Standards, have led to a growing demand for both efficient and effective security services and tools applied on the source code level. 75% of security breaches are a result of software flaws, according to Gartner. According to IBM, fixing breaches detected in the testing phase is 100 times more expensive than in the development phase.

Until now, cost-efficiency considerations have not allowed for proper, comprehensive security code review to be applied on large software packages, and technology considerations did not provide a solution for customized, thorough, quick, source code review or an appropriate solution for non-compiled code. Existing tools and services today cover only specific angles of this process and are limited in their capacity, which at times compromises the accuracy of the results or require the allocation of additional complementary resources and investment.

Cyber-attacks are on the rise. The rules of the game are rapidly shifting and changing. Building a secure product and a better security posture is no longer an option. It is both commercially essential in mature markets as well as can be served as a future market differentiator.

Prior art methods are limited in their attack surface area and depth of coverage. They do not attempt to rectify the problem at the source, but rather provide compensating controls at the perimeter level, therefore, usually serving solely as a second defense layer.

Prior art, generic static code analysis tools/solutions are inherently unaware of the specific structure and behavior of each application and therefore have to make many assumptions. They have two significant disadvantages:

creation of many warnings/false claims—the false positives; and

because they are generic they miss issues that are application specific—the false negatives

Thus, prior art solutions provide families of service solutions comprising generic cloud base source code review services, but the problems described above remain.

### SUMMARY OF THE INVENTION

Accordingly, it is a principal object of the present invention to provide a service with a methodology and to combine human input with a custom fit for each application structure to analyze the results before delivery, thereby minimizing the false negative rate and eliminating the false positives.

It is another principal object of the present invention to provide a framework and methodology designed for an innovative, customized, scalable and cost-efficient solution to target software based vulnerabilities from the source code level.

It is yet another principal object of the present invention to provide source code reviews in an automatic process framework combining best-of-breed and proprietary engines, unique heuristics and algorithms and manual analysis.

It is a further principal object of the present invention to apply the results of continuous research and experience of conducting static and dynamic code analysis of hundreds systems and products from various technologies, and implementing lessons learned into the methodology framework.

It is one other principal object of the present invention to provide zero percent false positives as well as controlled false negative ratio to detect software security vulnerabilities accurately and in time.

It is still another principal object of the present invention to transparently implement knowledge derived from hundreds of manual and automatic reviews into a customizable framework.

It is yet one other principal object of the present invention to provide out of the box, handling of most common programming languages used to develop software systems and products, e.g. various MS.NET languages, C/C++, Java, VB, ASP and PHP.

It is yet one further principal object of the present invention to provide inspection of generic security control, such as input validation, logging and error handling, as well as customizable application specific controls, such as authentication, access controls and authorizations.

It is still yet one other principal object of the present invention to be compatible with all common software security baselines and standards, such as OWASP, SANS, ISO and PCI.

Operational Benefits of the present invention:
1. Flexible mode of operation based on external cloud security as a service (SaaS) models;
2. Can start small and grow with customer needs;
3. Does not require software security expertise in-house;
4. Can easily scale to handle fast iterative scans for regression/retests after fixes;
5. Combines automated engines as well as advanced heuristics and customization methodology for scalable, efficient handling of large projects (up to millions of lines of codes (LOC's measured in thousands of lines (KLOCs)); and
6. Comprehensive and intuitive vulnerability reports with clear action items to follow.

The present invention provides a comprehensive, accurate, targeted method to detect potential security vulnerabilities, while still in the development stages. The solution is based both on automated and manual Static Code Analysis delivering custom tests that can be defined manually by a code review (CR) specialist with specific expertise in security code review and scripting. This provides the distinct advantage of performing Static Code Analysis at the speed and reduced cost of using automated tools, with the knowledge and know-how in source code querying and scripting by an experienced specialist. This is all possible without requiring the customer to buy expensive software, develop expertise in Security Code Review processes, or hire CR experts to operate and review Static Code Analysis tool results, as with other existing Static Code Analysis tools.

The present invention enables taking advantage of previous investment in the development of custom scripts resulting in a more effective process and more cost-efficient re-tests, such as addressing code fixes or minor version changes.

In addition to the traditional technical and executive summary reports, the present invention provides:
trend analysis reports for our clients that produce a substantial improvement over time in the quality of software code;
ensured progress in security proficiency and posture; and
managers' participation in the security development process, justifying investment in the service and allowing greater control of other security investments, such as awareness and training programs.

The customer requiring additional assistance in designing, implementing and deploying Software Security can seamlessly continue working with the same security consulting vendor who already possesses a deep familiarity of his systems and specific issues, rather than engaging additional vendors.

The present invention provides tailored packages and service approaches that are built upon the existing infrastructure, such as:
The fusion of automated Static Code Analysis engines partnered with an extensive in-house developed rule-base and methodology, able to accommodate small and large organizations alike by customizing the size and depth of projects for budget considerations. Static Code Analysis facilitates the Payment Card Industry Data Security Standard (PCI:DSS) compliance process for organizations in accordance with requirements 6.3.7 and 6.6 of the PCI:DSS. The PCI DSS is a set of policies and procedures intended to optimize the security of credit, debit and cash card transactions and protect cardholders against misuse of their personal information.

Repeat testing enables ongoing trend analysis that improves with time as a result of fine-tuning the customized rules, along with the security professionals' accumulated knowledge about your application, organization, and business context.

There has thus been outlined, rather broadly, the more important features of the invention in order that the detailed description thereof that follows hereinafter may be better understood. Additional details and advantages of the invention will be set forth in the detailed description, and in part will be appreciated from the description, or may be learned by practice of the invention.

### BRIEF DESCRIPTION OF THE DRAWINGS

In order to understand the invention and to see how it may be carried out in practice, a preferred embodiment will now be described, by way of a non-limiting example only, with reference to the accompanying drawings, in the drawings:

FIG. 1 is a schematic block diagram illustrating the General Architecture and Operation Concepts, constructed according to the principles of the present invention;

FIG. 2 is a schematic block diagram illustrating a solution based on the multitier concept, constructed according to the principles of the present invention;

FIG. 3 is a block diagram illustrating of the different modules composing the attack techniques knowledge base, constructed according to the principles of the present invention;

FIG. 4 is a block diagram illustrating four examples of the attack vectors of FIG. 3, constructed according to the principles of the present invention;

FIG. 5 is a schematic block diagram illustrating general detection heuristics for SQL injection attack, constructed according to the principles of the present invention;

FIG. 6 is a schematic block diagram illustrating the general methodology including components and tools, constructed according to the principles of the present invention; and

FIG. 7 is a flow chart illustrating the operational methodology, constructed according to the principles of the present invention.

All the above and other characteristics and advantages of the invention will be further understood through the following illustrative and non-limitative description of preferred embodiments thereof.

### DETAILED DESCRIPTION OF PREFERRED EMBODIMENTS

The principles and operation of a method and an apparatus according to the present invention may be better understood with reference to the drawings and the accompanying description, it being understood that these drawings are given for illustrative purposes only and are not meant to be limiting.

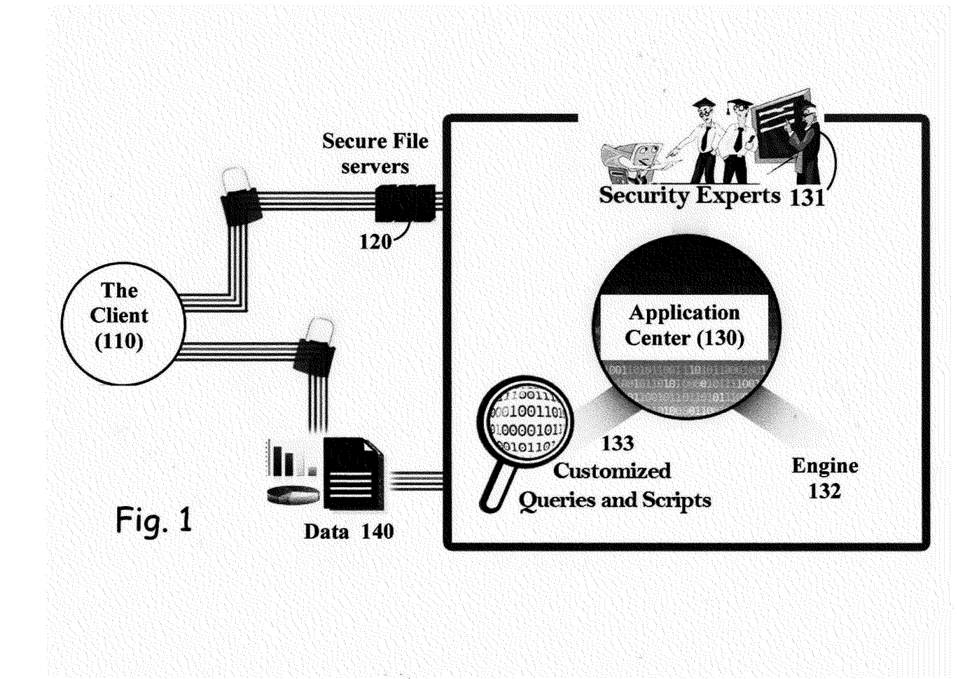

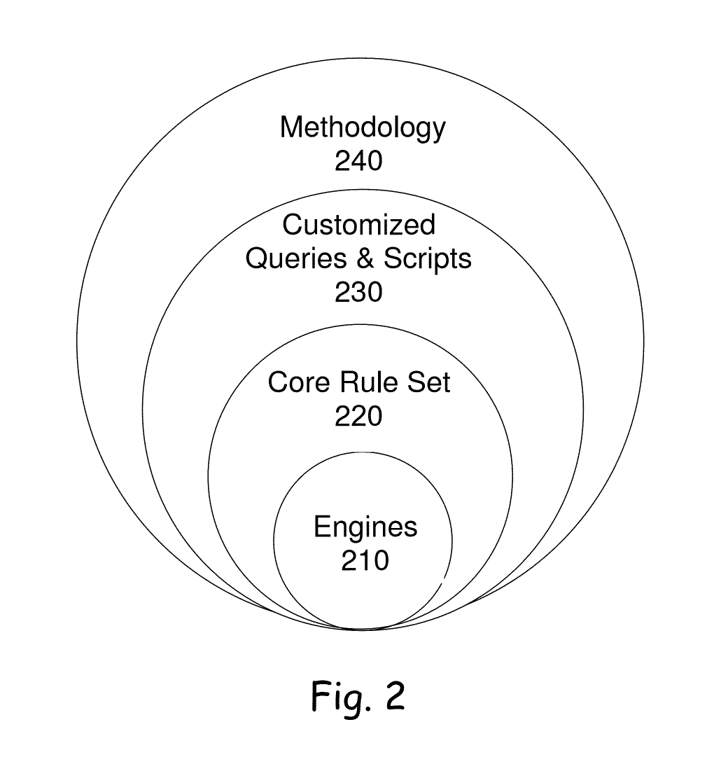

FIG. 1 is a schematic block diagram illustrating the general architecture and operating concepts, constructed according to the principles of the present invention.
1. The customer/client 110 uploads source code to the Security Code Review SaaS Application Center 130, along with data 140, such as general systems/product information, contact details and Depth service-level agreement (SLA) needed.
2. The source code is extracted by the Security Experts 131, and initial information is gathered through initial interaction with a technical contact at the customer/client side 110 regarding code's language, technology, structure and business context.
3. Customer customization is done via Custom CR Rules & scripts 133, that are developed based on code technology, structure and Depth SLA needed using the Rule Based framework. An SLA is a contract between a network service provider and a customer that specifies, usually in measurable terms, what services the network service provider will furnish.
4. In a case of a re-test, all information used for the previous test is loaded, including a previous rule set, final results and false positive/false negative analysis raw data.
5. Customized Rule Sets are loaded on the secure file processing servers 120 and the automated part of the Code Review starts.
6. Security Experts 131 perform a comprehensive analysis of the results to filter false positives, adjust the system in case of potential false negative alerts and initiate another analysis round until a pre-determined objective is accomplished.
7. All security vulnerabilities detected during the process are collected and transferred to Reporting Servers.
8. Security experts 131 perform analysis of the first report draft, and adjust risks levels as well as suggested mitigations.
9. A Final report is developed to provide a detailed description of the detected vulnerabilities, risk analysis, actionable recommendations, including technical details and actual code pieces, in a user-friendly and practical format.
10. The Engine 132 is based on three types of engines, as described below, with respect to FIG. 2:

FIG. 2 is a schematic block diagram illustrating a solution based on the multitier concept of three types of engines, constructed according to the principles of the present invention. In an exemplary preferred embodiment engines 210 include three types of engines:

### 1. Commercial Best of Breed Engines

i. Tailored to fit the framework of the present invention
ii. Currently supporting leading static code analysis engines
iii. Full coverage of all common programming languages and development platforms

### 2. Open Source Engines

i. Tailored to fit the framework of the present invention
ii. Currently supporting leading static code analysis engines and tools
iii. Each static code analysis engine is usually able to deal with specific technology & attack vector

### 3. Unique Proprietary Engines

i. Custom engines that were developed to cover gaps not covered in other engines
ii. Focused on specific attack vectors and technology
iii. Usually assists hard cases were other engines fails in coverage

The Core Rule Set 220 is the “heart” of the present invention and is composed of a comprehensive knowledge bank covering all types of logic. Core rule set 220 relates to the performance of Security Code Reviews in various technologies, development frameworks and programming languages.

Customer customization is done via customized queries and scripts 230, that are developed based on code technology, structure and Depth SLA needed using the Rule Based framework.

The Methodology component 240 is the process, methods, tools and supporting systems uniquely and transparently used by the solution experts to perform their work.

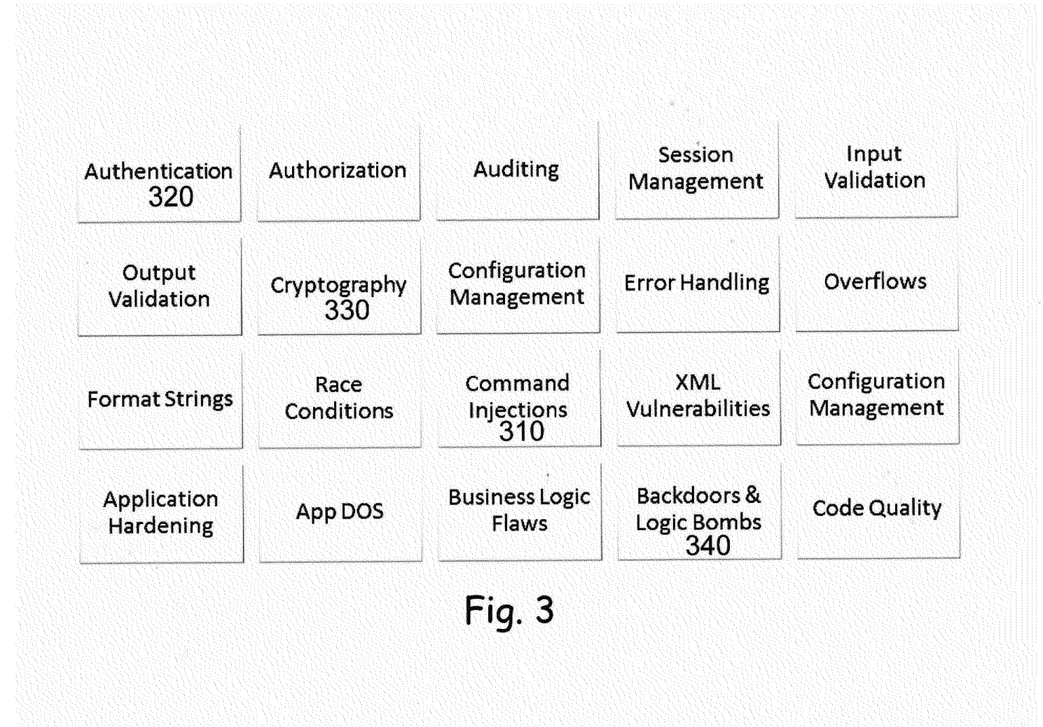

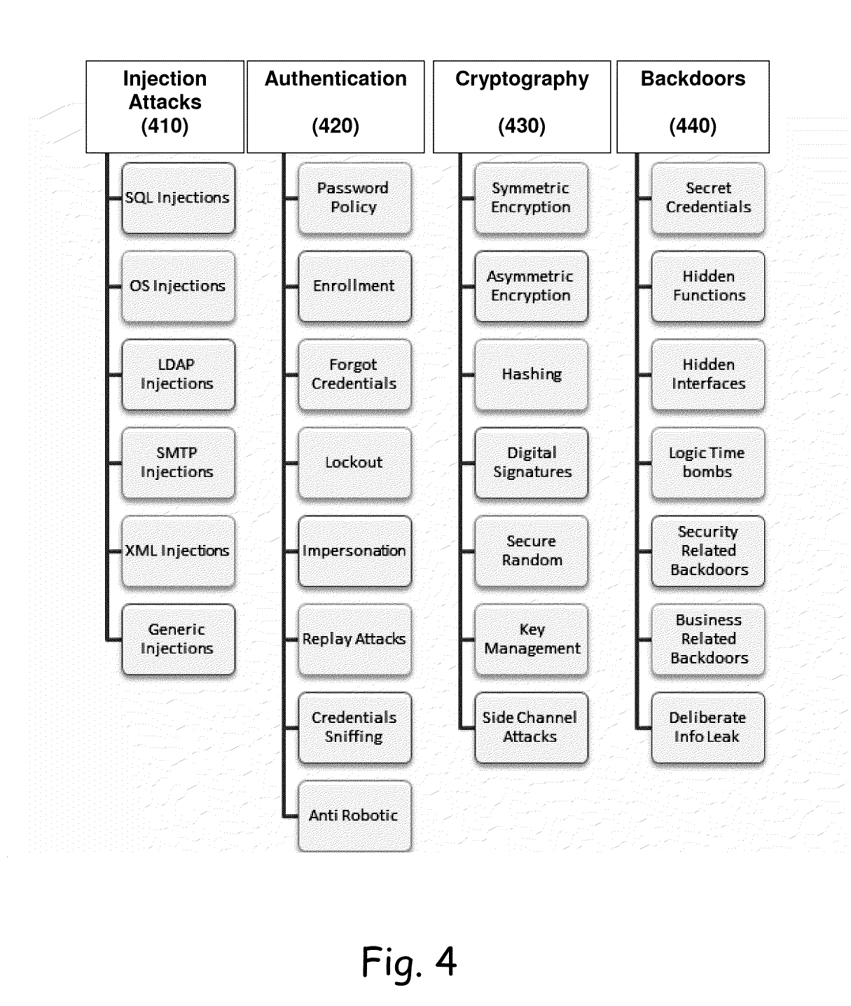

FIG. 3 is a block diagram illustrating the different modules composing the attack techniques knowledge base, constructed according to the principles of the present invention. Each module is composed of tens to hundreds of different types of attacks. Modules representing injection attacks 310, authentication 320, cryptography 330 and backdoors 340 are further delineated in FIG. 4

FIG. 4 is a block diagram illustrating four examples of the attack vectors of FIG. 3, constructed according to the principles of the present invention. Each of the four modules is further elaborated into a group of attack family, which in turn composed of a list of a concrete attack patterns and techniques used as part of the Core Rule Set. The Attack Techniques knowledge base is comprehensive and covers all well-known attack vectors and techniques and is updated on a monthly basis.

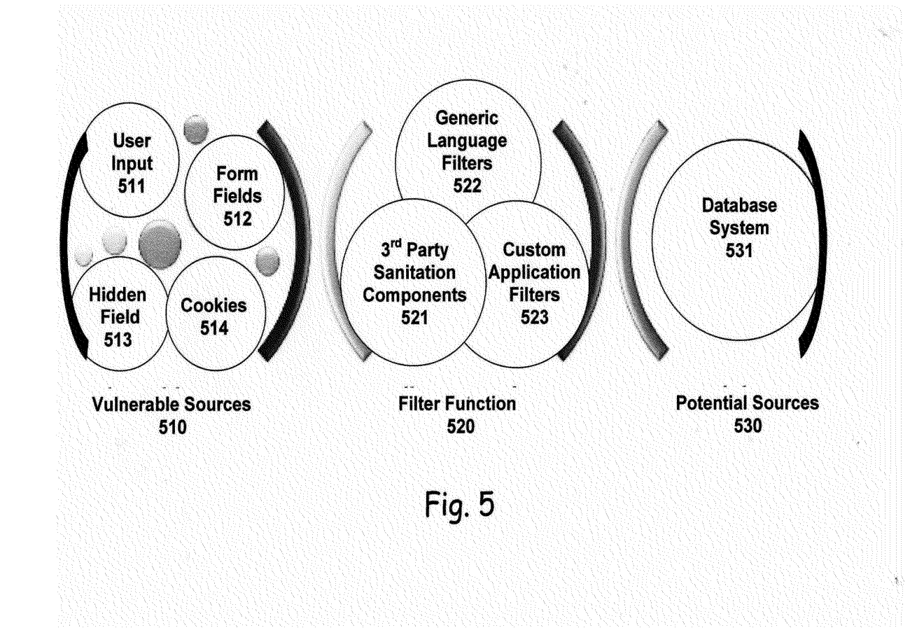

FIG. 5 is a schematic block diagram illustrating general detection heuristics for a Structured Query Language (SQL) injection attack, constructed according to the principles of the present invention. Detection Heuristics include advanced heuristics and algorithms that are the written by software security experts. Detection Heuristics cover the entirety of Core Set modules, and provide a high level logic for the detection of potential software security vulnerabilities within a given software source code.

An example for a generic detection heuristics for SQL Injection attack is illustrated in FIG. 5. In the example, the detection heuristic tries to find a potentially vulnerable source 510 in the form of a user input 511, that has a dataflow to a potential source 530 in the database 531 (data sink) without going through proper filtering 520, as embodied in 3^{rd} party sanitation components 521. Other vulnerable sources include form fields 512, hidden fields 513 and cookies 514. Other filter functions include generic language filters 522 and custom application filters 523

The detection heuristics given as examples here are considered generic. Generally they are composed of more detailed detection heuristics algorithms for each common programming language and development environment.

The Policy Compliance component of the Core Rule Set provides mapping between the attack techniques and detection heuristics and the practices and compliance requirements existing today. Policy compliance is used as a standard for secure development of software products and can be easily adjusted to tailor specific enterprise/software vendor needs, integrating standards/regulation requirements with internal customer policy.

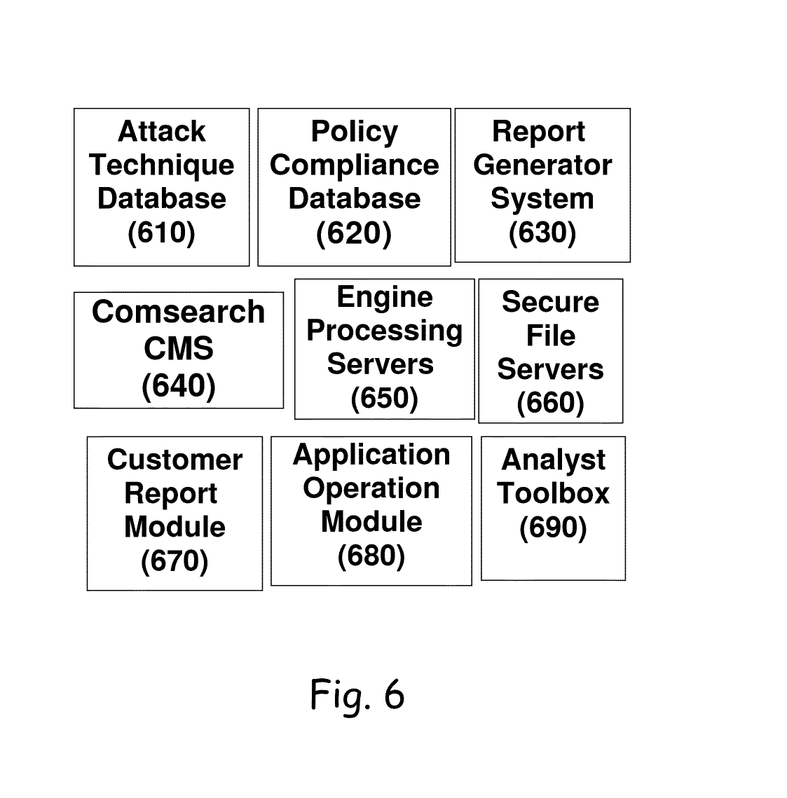

FIG. 6 is a schematic block diagram illustrating the general methodology including components and tools, constructed according to the principles of the present invention.

A general description of each of the Methodology and Support Systems components is as follows:
1. Attack Technique Database 610—relational database management system (DBMS) holding attack techniques and vectors per technology and programming language as described previously in this document. Attack techniques is a knowledge base covering rules, scripts, examples and details of all modern attack vectors, which exploit vulnerability at the application level.
2. Policy Compliance Database —620 relational DBMS holding Policy Compliance requirements, weaknesses and attack vectors in addition to mapping between the different standards to a proprietary internal format based on MITRE's Common Weakness Enumeration (CWE). CWE is a universal online dictionary of weaknesses that have been found in computer software. The dictionary is maintained by the MITRE Corporation and can be accessed free.
3. Report Generator System —630 a central tool used by the analyst to upload scan results, perform the risk rating analysis, adjust policy compliance requirements, customize mitigations and generate a customer report. Supports both PDF and XLS for exports.
4. ComSearch CMS —640 the main knowledge management system, used as a content management system (CMS) for customer information and requirements, scan results and deliverables.
5. Engine Processing Servers —650 internal server farm used to solely run the different engines (described previously). Can easily scale to support high load whenever parallel/heavy scans are required.
6. Secure File Servers —660 server farm used to provide secure transport for clients to transfer source code to Application Center 130, with reference to FIG. 1.
7. Customer Report Portal —670 external facing customer portal that provide access to code analysis results in various reporting formats, e.g. executive summary, developers report, trend analysis
8. Operation Module —680 proprietary methodology, processes, procedures and tools developed by the experts. and used for the ongoing operation of Application Center 130, with reference to FIG. 1.
9. Analyst Toolbox —690 proprietary toolbox includes all the tools, checklists and scripts used by the analysts to perform their work. The toolbox includes both commercial, open source and custom home-made tools and scripts developed specifically for the analysis task

Attack Techniques are a knowledge base covering rules, scripts, examples and details covering all modern attack vectors used today to perform attacks and exploits vulnerability at the application level.

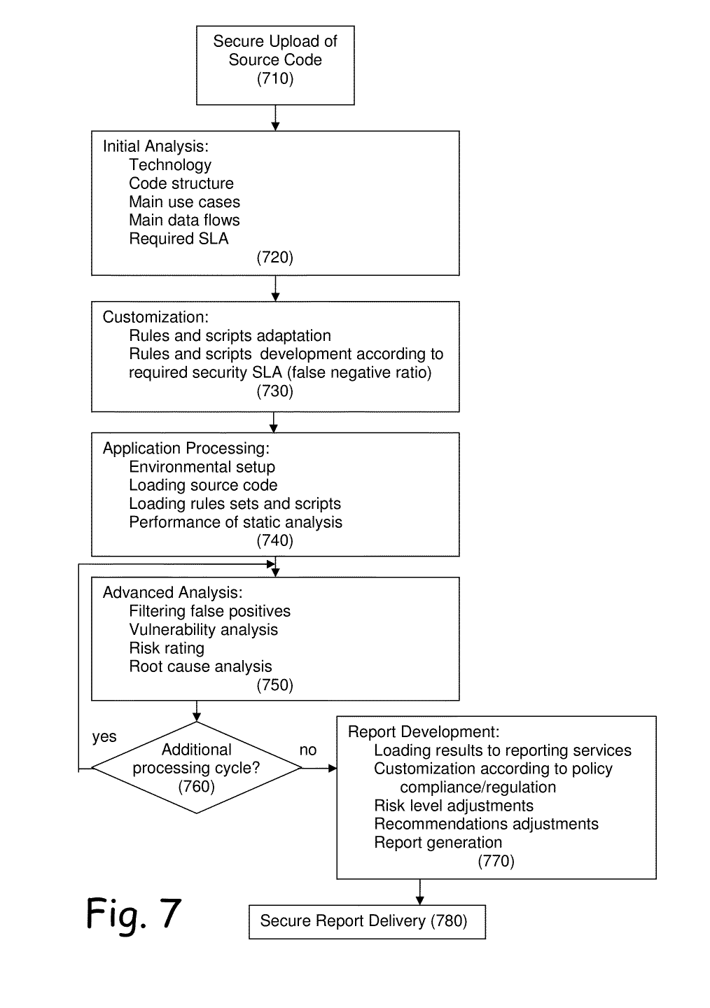

FIG. 7 is a flow chart illustrating the operational methodology, constructed according to the principles of the present invention. The first step is secure upload of the source code 710.

Initial Analysis 720 involves:
Technology;
Code structure;
Main use cases;
Main data flows; and
Required SLA.
   Customization 730 includes:
Rules and scripts adaptation; and
Rules and scripts development according to required security SLA (false negative ratio).
   Application Processing 740 comprises:
Environmental setup;
Loading source code;
Loading rules sets and scripts; and
Performance of static analysis.
   Advanced Analysis 750 provides:
Filtering false positives;
Vulnerability analysis;
Risk rating; and
Root cause analysis.

If an additional processing cycle is needed 760, advanced analysis 750 is repeated; if not, Report Development 770 is performed:
Loading results to reporting services;
Customization according to policy compliance/regulation;
Risk level adjustments;
Recommendations adjustments; and
Report generation.
   Finally a Secure Report is delivered 780.

The following examples demonstrate common standards used in industry today covered by the Policy Compliance component.

OWASP Top 10 2013 Support

The Open Web Application Security Project (OWASP) is an open-source application security project and considered as the most common resource for secure development. One of OWASP's successful projects is the OWASP's Top 10 that enlists the most common security vulnerabilities existing in current web applications.

Other potential security vulnerabilities covered by other popular OWASP projects, e.g. Secure Guide, Comprehensive Lightweight Application Security Process (CLASP), are also covered by the Policy Compliance module. CLASP is an activity-driven, role based set of process components whose core contains formalized best practices for building security into your existing or new-start software development lifecycles in a structured, repeatable, and measurable way.

Injection Flaws, such as SQL, operating system (OS), and Lightweight Directory Access Protocol (LDAP) injection occur when untrustworthy data is sent to an interpreter as part of a command or query. The attacker's hostile data can trick the interpreter into executing unintended commands or accessing unauthorized data. LDAP injection is a specific form of attack compromising Web sites that construct LDAP statements from data provided by users. This is done by changing LDAP statements so dynamic Web applications can run with invalid permissions.

Application Functions Related to Broken Authentication and Session Management are often not implemented correctly, allowing attackers to compromise passwords, keys, session tokens, or exploit other implementation flaws to assume other users' identities.

Cross-Site Scripting (XSS) flaws occur whenever an application takes untrusted data and sends it to a web browser without proper validation or escaping. XSS allows attackers to execute scripts in the victim's browser which can hijack user sessions, deface web sites, or redirect the user to malicious sites.

Insecure Direct Object References occurs when a developer exposes a reference to an internal implementation object, such as a file, directory, or database key. Without an access control check or other protection, attackers can manipulate these references to access unauthorized data.

Security Misconfiguration—Good security requires having a secure configuration defined and deployed for frameworks, application server, web server, database server, and platform. All these settings should be defined, implemented and maintained as many are not shipped with secure defaults. This includes keeping all software up to date.

Sensitive Data Exposure—Many web applications do not properly protect sensitive data, such as credit cards, tax ID's, and authentication credentials. Attackers may steal or modify such weakly protected data to conduct identity theft, credit card fraud, or other crimes. Sensitive data deserves extra protection, such as encryption at rest or in transit, as well as special precautions when exchanged with the browser.

Missing Function Level Access Control—Virtually all web applications verify function level access rights before making that functionality visible in the user interface (UI). However, applications need to perform the same access control checks on the server when each function is accessed. If requests are not verified, attackers will be able to forge requests in order to access unauthorized functionality.

A Cross-Site Forgery Request (CSRF) attack forces a lagged-on victim's browser to send a forged HTTP request, including the victim's session cookie and any other automatically included authentication information, to a vulnerable web application. This allows the attacker to force the victim's browser to generate requests the vulnerable application thinks are legitimate requests from the victim.

Vulnerable components, such as libraries, frameworks, and other software modules almost always run with full privileges. So, if exploited, they can cause serious data loss or server takeover. Applications using these vulnerable components may undermine their defenses and enable a range of possible attacks and impacts.

Invalidated Redirects and Forwards—Web applications frequently redirect and forward users to other pages and websites, and use untrustworthy data to determine the destination pages. Without proper validation, attackers can redirect victims to phishing or malware sites, or use forwards to access unauthorized pages.

CWE/SANS Top 25 2011 Support

The 2011 CWE/SANS Top 25 Most Dangerous Software Errors is a list of the most widespread and critical errors that can lead to serious vulnerabilities in software. They are often easy to find, and easy to exploit. They are dangerous because they will frequently allow attackers to completely take over the software, steal data or prevent the software from working at all.

The list is the result of collaboration between the System Administration, Networking, and Security (SANS) Institute, MITRE, and many top software security experts in the US and Europe. It leverages experiences in the development of the SANS Top 20 attack vectors and MITRE's Common Weakness Enumeration (CWE) with the support of the US Department of Homeland Security's National Cyber Security Division. MITRE is an American not-for-profit security organization.

The SANS Top 25 list is composed of the following categories:

Insecure Interaction Between Components

These weaknesses are related to insecure ways in which data is sent and received between separate components, modules, programs, processes, threads or systems, as shown in Table I below:

TABLE I

| Rank | CWE ID | Name |
|---|---|---|
| [1] | CWE-89 | Improper Neutralization of Special Elements used |
| | | in an SQL Command (‘SQL Injection’) |
| [2] | CWE-78 | Improper Neutralization of Special Elements used |
| | | in an OS Command (‘OS Command Injection’) |
| [4] | CWE-79 | Improper Neutralization of Input During Web Page |
| | | Generation (‘Cross-site Scripting’) |
| [9] | CWE-434 | Unrestricted Upload of File with Dangerous Type |
| [12] | CWE-352 | Cross-Site Request Forgery (CSRF) |
| [22] | CWE-601 | URL Redirection to Untrusted Site (‘Open Redirect’) |

### Risky Resource Management

The weaknesses in this category are related to ways in which software does not properly manage the creation, usage, transfer or destruction of important system resources, as shown in Table II below:

TABLE II

| Rank | CWE ID | Name |
|---|---|---|
| [3] | CWE-120 | Buffer Copy without Checking Size of Input (‘Classic |
| | | Buffer Overflow’) |
| [13] | CWE-22 | Improper Limitation of a Pathname to a Restricted |
| | | Directory (‘Path Traversal’) |
| [14] | CWE-494 | Download of Code Without Integrity Check |
| [16] | CWE-829 | Inclusion of Functionality from Untrusted Control |
| | | Sphere |
| [18] | CWE-676 | Use of Potentially Dangerous Function |
| [20] | CWE-131 | Incorrect Calculation of Buffer Size |
| [23] | CWE-134 | Uncontrolled Format String |
| [24] | CWE-190 | Integer Overflow or Wraparound |

### Porous Defenses

The weaknesses in this category are related to defensive techniques that are often misused, abused, or just plain ignored, as shown in Table III below:

TABLE III

| Rank | CWE ID | Name |
|---|---|---|
| [5] | CWE-306 | Missing Authentication for Critical Function |
| [6] | CWE-862 | Missing Authorization |
| [7] | CWE-798 | Use of Hard-coded Credentials |
| [8] | CWE-311 | Missing Encryption of Sensitive Data |
| [10] | CWE-807 | Reliance on Untrusted Inputs in a Security Decision |
| [11] | CWE-250 | Execution with Unnecessary Privileges |
| [15] | CWE-863 | Incorrect Authorization |
| [17] | CWE-732 | Incorrect Permission Assignment for Critical Resource |
| [19] | CWE-327 | Use of a Broken or Risky Cryptographic Algorithm |
| [21] | CWE-307 | Improper Restriction of Excessive Authentication |
| | | Attempts |
| [25] | CWE-759 | Use of a One-Way Hash without a Salt |

### WASC Threat Classification v2.0 Support

The Web Application Security Consortium (WASC) is a nonprofit made up of an international group of experts, industry practitioners, and organizational representatives who produce open source and widely agreed upon best-practice security standards for the World Wide Web.

The WASC Threat Classification is a cooperative effort to clarify and organize the threats to the security of a web site. The Threat Classification v2.0 outlines the attacks and weaknesses that can lead to the compromise of a website, its data, or its users. This project primarily serves as a reference guide for each given attack or weakness and provides examples of each issue as well as helpful reference material. This document is utilized by many organizations and is typically used in the following ways, as shown in Table IV below:

TABLE IV

| Attacks | Weaknesses |
|---|---|
| Abuse of Functionality | Application Misconfiguration |
| Brute Force | Directory Indexing |
| Buffer Overflow | Improper Filesystem Permissions |
| Content Spoofing | Improper Input Handling |
| Credential/Session Prediction | Improper Output Handling |
| Cross-Site Scripting | Information Leakage |
| Cross-Site Request Forgery | Insecure Indexing |
| Denial of Service | Insufficient Anti-automation |
| Fingerprinting | Insufficient Authentication |
| Format String | Insufficient Authorization |
| HTTP Response Smuggling | Insufficient Password Recovery |
| HTTP Response Splitting | Insufficient Process Validation |
| HTTP Request Smuggling | Insufficient Session Expiration |
| HTTP Request Splitting | Insufficient Transport Layer Protection |
| Integer Overflows | Server Misconfiguration |
| LDAP Injection | |
| Mail Command Injection | |
| Null Byte Injection | |
| OS Commanding | |
| Path Traversal | |
| Predictable Resource Location | |
| Remote File Inclusion (RFI) | |
| Routing Detour | |
| Session Fixation | |
| SOAP Array Abuse | |

Customized Queries and Scripts are performed by security experts, while tailoring the Core Rule Set to suit customer applications/product.

Experience with best of breed static and dynamic source code analyzers and performing large amount of manual code inspections, led our software security experts to conclude that existing solutions in market simply does not meet customer demands and expectations:

Static and Dynamic Code Analyzers are too generic. They concentrate on finding generic vulnerabilities thus missing unique application logic. It might be incorrectly understood that the unique part is considered insignificant. The reality however, is different. Unique logic surrounds many critical security aspects and mechanisms, authentication and authorization, for example. The above mentioned phenomena lead to a high percentage of false negatives of the automated analyzers.

In addition, the generic behavior of the automated analyzers generates high percentage of false positives. The result, an average of 1 warning/error per 10-100 lines of code. With an average of 5 minutes to analyze each error/warning raised by the tool it might take an average of five months to review one million LOC software, which simply does not withstand customer's expectations, not to mention the work invested by the security expert using the tool.

Manual security reviews do not scale. In this case without using an automated tool it might take forever to review millions LOC software and with current business demands this simply cannot happen leading to compromise on sampling approaches and again high percentage of potential false negatives.

The solution that was adapted is a hybrid approach. This way most “dirty” work can be still performed by automated engines but with a few differences:
Generic engines will not run out of the box. They will be selected carefully to match the reviewed technology and if needed a combination of multiple engines will be used to minimize false negative ratio.
Generic engines will not use out of the box rules/policies. They will use a customized version of the Core Rule Set that was adapted and tailored to the specific software technology and structure, i.e., the Customized Queries & Scripts component.
The SQL Injection detection heuristics example is frequently used by static code analyzers to detect generic SQL Injection flaws, which demonstrate the arguments mentioned above:
Using a static/generic list of <sources> is limiting. The system might have other less generic entry points or a different technology/data flow structure the tools might simply miss. As a result, there is a higher percentage of false negatives.
Using a static/generic list of <destination> is even more limiting. Most complex systems do not simply work directly with databases. They use data layers or application logic resulting in a dataflow disconnection and their tools are unable to determine which dataflow results in database access. The result is a high percentage of false negatives.
Using a static/generic list of <filters> is limited. In many cases, complex software or well established software houses have their own libraries for input sanitation, sometime even with no source code available. The result is a high percentage of false positives, since the “correct” filters were not detected.

By contrast, the present invention employs a manual phase performed by a security expert customizing the Core Rule Set with tailored rules, queries and scripts to make sure that the “proper” functions, according to the inspected software technology and structure are used. In this case a proper list of <sources/entry-points>, <destinations/sinks> and <filter-functions>.

Having described the present invention with regard to certain specific embodiments thereof, it is to be understood that the description is not meant as a limitation, since further modifications will now suggest themselves to those skilled in the art, and it is intended to cover such modifications as fall within the scope of the appended claims.

We claim:

1. A method for a customized, scalable and cost-efficient solution to enable source code level solutions to provide zero percent false positives as well as a controlled false negative ratio to detect software security vulnerabilities accurately and in time, the method comprising:
secure uploading of the source code;
initial analyzing;
customizing according to accuracy and depth defined to enable control of the false negative ratio providing:
rules and scripts adapting; and
rules and scripts developing according to required the security SLA;
application processing;
advanced analyzing; and
performing report development.

2. The method according to claim 1, further comprising repeating the advanced analyzing step each time an additional processing cycle is needed.

3. The method according to claim 1, wherein the initial analyzing involves at least one of:
technology;
code structure;
main use cases;
main data flows; and
any required service level agreement (SLA)

4. The method according to claim 1, wherein the method enables zero (0) percent false positives.

5. The method according to claim 1, wherein the advanced analyzing comprises at least one of:
filtering false positives;
vulnerability analyzing;
risk rating; and
root cause analyzing

6. The method according to claim 1, wherein the application processing comprises at least one of:
environmental setting up;
loading source code;
loading rules sets and scripts; and
performing static analysis

7. The method according to claim 1, further comprising providing cloud-based code review service.

8. The method according to claim 1, wherein performing report development comprises at least one of:
loading results to reporting services;
customizing according to policy compliance/regulation;
risk level adjusting;
recommending and adjusting;
report generating; and
delivering a secure report

9. The method according to claim 1, wherein a human analyst is “built-in” as part of the process that performs the analysis on initial results and the filtering of the results to contain ONLY relevant security vulnerabilities.

10. The method according to claim 1, further comprising providing a core rule set composed of a comprehensive knowledge bank covering attack and mitigation logic and relating to the performance of security code reviews in a plurality of technologies, development frameworks and programming languages.

11. The method according to claim 10, further comprising providing customer customization done via customized queries and scripts based on code technology, structure and the in-depth SLA needed using the core rule set framework.

12. The method according to claim 1, further comprising mapping of existing commercial and open source tools to perform security code review projects regarding attack vectors, vulnerability patterns, programming languages and development frameworks.
